(19) United States
(12) Patent Application Publication
(10) Pub. No.: US 2007/0216181 A1
(43) Pub. Date: Sep. 20, 2007

(54) CENTER CONSOLE

(75) Inventors: Robert M. Schmidt, Livonia, MI (US); Anthony Walowich, Allen Park, MI (US)

Correspondence Address: BROOKS KUSHMAN P.C. / LEAR CORPORATION, 1000 TOWN CENTER, TWENTY-SECOND FLOOR, SOUTHFIELD, MI, 48075-1238, US

(73) Assignee: LEAR CORPORATION, Southfield, MI (US)

(21) Appl. No.: 11/276,769

(22) Filed: Mar. 14, 2006

(51) Int. Cl. B60R 7/04

(52) U.S. Cl. 296/24.34

(57) ABSTRACT

A center console for a vehicle. The console includes a base body incorporating at least two stowage compartments that can be selectively covered by a slidingly mounted cover panel. A flexible flat cable is connected at a first end to the cover panel and at a second end to the base body at a connection point. The base body also has a retraction and extraction compartment open at least towards the cover panel in and from which at least a portion of the flat cable is mounted so that it can be retracted and extracted when the cover panel is displaced.

### BACKGROUND OF THE INVENTION

1. Field of the Invention

The present invention relates to a center console for a vehicle.

2. Background Art

An example of a center console is described in WO 01/08927.

### SUMMARY OF THE INVENTION

In at least one embodiment of the present invention, a center console for a vehicle is provided. The center console includes a cover panel. For the purpose of the invention, the cover panel is slidingly mounted so that it selectively covers or exposes at least two stowage compartments of a base body. A co-operating flat cable is connected to the cover panel by its first end to supply co-operating electrical units inside the cover panel. The flat cable may also be secured to a connection point in the base body by means of its second end. To enable the flat cable to move with the cover panel as it slides, at least one retraction and extraction compartment is provided in the base body between the stowage compartments to cover the open stowage compartments. The flat cable is pushed out or pulled out when the cover panel is moved in one direction and is pushed in during a movement in the other direction. The flat cable is protected by the retraction and extraction compartment, while sufficient space is simultaneously provided to retract and extract it.

The sliding displacement of the cover panel obviates the need for a co-operating pivot axis, while simultaneously requiring less space to open one or the other stowage compartment. In addition, the flat cable is reliably protected from being bent too sharply or from other damage inside the retraction and extraction compartment between the stowage compartments. There is no need for additional devices to pull the flat cable into the retraction and extraction compartment because the accompanying guiding action of the first end of the flat cable pulls it out of or retracts it into the compartment as the cover panel is moved.

It is possible to dispose the retraction and extraction compartment at one end of the base body adjacent to one stowage compartment. However, this retraction and extraction compartment is preferably disposed between the stowage compartments in the displacement direction of the cover panel. As a result, the flat cable is pulled out or guided back into the compartment to the minimum possible degree as the cover panel slides.

The retraction and extraction compartment may extend at an angle to the displacement direction of the cover panel. However, in order to move the flat cable to the same degree as the cover panel as it moves along the retraction and extraction compartment, the retraction and extraction compartment may extend essentially perpendicular to the displacement direction of the cover panel.

The flat cable is moved to a greater or lesser degree depending on the size of the stowage compartments and hence depending on the length of the sliding movement of the cover panel. In this connection, it may be of advantage if the retraction and extraction compartment has a terminal opening at its end remote from the cover panel for running the flat cable in the direction towards the connection point. The movement of the flat cable is therefore not restricted to the retraction and extraction compartment but can also be pulled out of it or pushed back into it through the co-operating terminal opening.

To help inhibit the flat cable from assuming a waved pattern or even moving out of line as it moves, the flat cable can be guided during its movement inside the retraction and extraction compartment.

In this connection, it may be of advantage if an essentially slot-shaped guide part is run through the retraction and extraction compartment and the flat cable secured to it.

There are various conceivable possibilities for guiding the guide part accordingly inside the retraction and extraction compartment. An example of a simple embodiment for providing such guiding action may be one in which the guide part has guide projections on both sides, projecting in the transverse direction of the flat cable and beyond it, which are accommodated by guides provided inside the retraction and extraction compartment.

As the cover panel moves past an aperture of the retraction and extraction compartment co-operating with it, the flat cable is fed past a co-operating aperture edge of this aperture. To support it and reliably prevent any bending at this point during its movement, the front aperture of the retraction and extraction compartment co-operating with the cover panel may have at least one outwardly bent edge portion. As a result of this co-operating bend of the edge portion, the flat cable is also guided along this bend, thereby reliably preventing any bending as the cover panel is moved accordingly.

Another possibility is to dispose the flat cable almost completely inside the retraction and extraction compartment so that it is protected relative to the other units of the base body or parts disposed on the front of and outside the base body, for example. This being the case, it may also be of advantage if the connection point is disposed inside the retraction and extraction compartment. In the case of such an arrangement, the connection point may be disposed essentially close to the front aperture of the retraction and extraction compartment, for example, in which case the flat cable is guided from here to the oppositely lying end of the compartment and then bent back towards the front end and hence to its connection point on the cover panel.

An example of another embodiment offering advantages is one in which a plug connector is provided at the connection point. Such a plug connector might be a ZIF (Zero Insertion Force) connector, for example, by means of which the flat cable can be connected directly to other flat cables or other electrical connecting wires in the vehicle when the center console is fitted.

It would naturally also be possible for this connection point to be assigned essentially to the terminal opening of the retraction and extraction compartment. This will facilitate connection to the vehicle's units.

In addition or as an alternative to the bent edge portion on the front aperture of the retraction and extraction compartment, it would also be possible for the guide to have an outwardly bent edge portion at its end directed towards the cover panel.

It would be conceivable for the flat cable to be connected to the cover panel more or less at its center in the direction of displacement. Disposing the retraction and extraction compartment accordingly between the two stowage compartments would ensure that the flat cable is bent round the one stowage compartment or the other stowage compartment as it moves past and along the corresponding bent edge portion as the cover panel moves past. In this example of an embodiment, however, the flat cable is bent in two opposing directions. To avoid this, however, the flat cable may be connected to the cover panel at a cover panel end portion disposed in its displacement direction on its internal face directed towards the stowage compartments. This offers the possibility of bending the flat cable to one side only when running it past the cover panel, for example if one compartment is partially or completely covered by the cover panel, whereas it will run in an essentially straight line in the direction of the cover panel if the latter is covering the other compartment.

Depending on the embodiment, the flat cable may supply power to different units on or in the cover panel. For example, the cover panel may have keys, buttons, switches, display units or such like on its external face that are electrically connected to the flat cable. In this connection, it goes without saying that the electrical connection may be used not only to transmit voltage but also data.

To protect the flat cable whatever the position of the cover panel, the cover panel may be disposed so that it overlaps the retraction and extraction compartment in its respective end positions in the direction of displacement. This ensures that the co-operating terminal opening is always closed by the cover panel, ensuring that the flat cable is not accessible from the outside or can not come into contact with objects disposed in the stowage compartments in any way.

In addition or as an alternative to the carriage-type guide part, it is also possible for the flat cable to be guided directly at the side inside the retraction and extraction compartment. This can be achieved by means of projections engaging at least partially round the flat cable, which advantageously extend at least in the region of the terminal opening.

The co-operating base body of the center console may be made from various materials, in which case it is preferable to opt for a sufficiently strong plastic material. In particular, the base body may be produced as a single piece incorporating the stowage compartments, retraction and extraction compartment and guides and optionally also other individual parts of the center console. This may be achieved by molding a plastic material accordingly for example.

To make it easier to fit the center console in an orifice in the vehicle, the base body may have a releasably fitted aperture frame in which the cover panel is displaceably mounted. When the center console is fitted, this firstly enables the base body to be inserted in the co-operating orifice and secured there. The aperture frame is then fitted on the base body and secured to it by catches or similar. The aperture frame is fitted together with the cover panel.

To increase the strength of the cover panel, particularly during its displacement, the cover panel may have a guide projection on its internal face essentially at the center, which is guided in a guide groove of the base body. An example of an embodiment of such a guide projection is a toothed strip, which meshes with a gear or similar disposed in the co-operating guide groove of the base body.

The engagement of the guide projection and guide groove may be used as a means of applying a certain resistance when the cover panel is displaced and also as a means of ensuring that it is retained in its end positions and does not move away from them of its own accord. There are other possible ways of retaining the cover panel in its end positions, in which case a latching system would also be conceivable.

To protect and optionally strengthen the flat cable, in particular in the partial portion by which it is extracted and retracted from the terminal opening as the cover panel slides, the flat cable may be mounted on a flexible strip at least along this part of its length. In this connection, another possibility is to secure the carriage-type guide part not directly to the flat cable but to this flexible strip. It would also be conceivable for this flexible strip to be guided directly in an appropriate guide inside the retraction and extraction compartment.

To protect the flat cable from contact with objects disposed in the stowage compartment if necessary as the cover panel is moved across a co-operating stowage compartment, the cover panel may have a recess on its internal face for accommodating a co-operating partial portion of the flat cable. Consequently, the flat cable is recessed in the internal face of the cover panel, largely avoiding contact with one or the other of the objects disposed in the stowage compartments.

Examples of advantageous embodiments of the invention will be described in more detail with reference to the diagrams of the appended drawings.

### BRIEF DESCRIPTION OF THE DRAWINGS

FIG. 1 is a side perspective view showing an example of an embodiment of a center console with an aperture frame and a cover panel disposed in one end position;

FIG. 2 shows the embodiment illustrated in FIG. 1 with the cover panel disposed in a second end position;

FIG. 3 shows the center console illustrated in FIGS. 1 or 2 without a cover panel and aperture frame;

FIG. 4 shows a section through the center console illustrated in FIG. 1, along the plane indicated by IV-IV;

FIG. 5 is an enlarged diagram showing a retraction and extraction compartment as illustrated in FIG. 4;

FIG. 6 is a front view of the embodiment illustrated as an example in FIG. 5;

FIG. 7 is a detailed view of a guide part illustrated in FIG. 5;

FIG. 8 shows a section corresponding to that of FIG. 4 for a first position of the cover panel;

FIG. 9 shows a section similar to that of FIG. 8 for a center position of the cover panel;

FIG. 10 shows a section similar to that of FIG. 8 with the cover panel in another position; and

FIG. 11 is a perspective view seen at an angle from the rear of a partially cut-away base body of a center console as illustrated in FIGS. 1 or 2.

### DETAILED DESCRIPTION

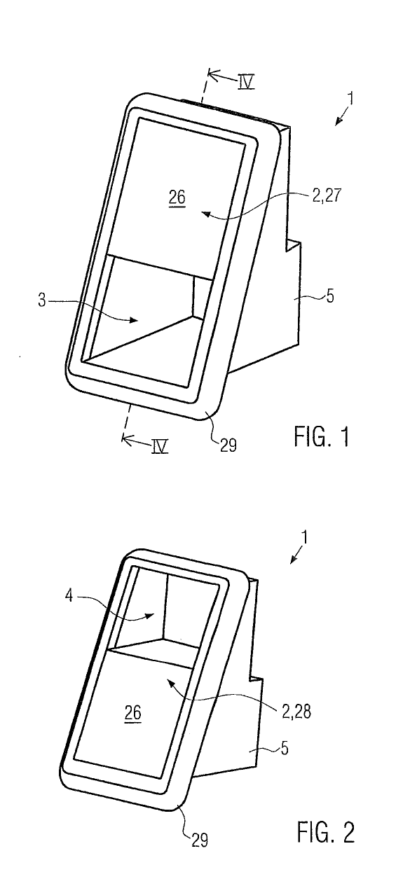

FIGS. 1 and 2 illustrate two perspective side views of an example of an embodiment of a center console 1 proposed by the invention. In FIG. 1, a co-operating cover panel 2 is disposed in a top end position 27 and in FIG. 2 in a bottom end position 28. In the top end position 27, a bottom stowage compartment 3 is respectively opened and in the bottom end position 28, a top stowage compartment 4 in a base body 5 of the center console 1 is respectively opened and thus accessible for inserting or removing objects.

Releasably placed on the co-operating base body 5 of the center console 1 is an aperture frame 29, in which the cover panel 2 is slidingly mounted. The cover panel 2 is directed with its external face 26 towards the vehicle interior. Moreover, the center console 1 may be inserted so deep in an appropriate orifice in the vehicle interior that only the aperture frame 29 with cover panel 2 sit proud. An appropriate orifice may be provided in the vehicle interior in the region of a dashboard, underneath it, between the front or rear seats or also in an arm rest or similar, for example.

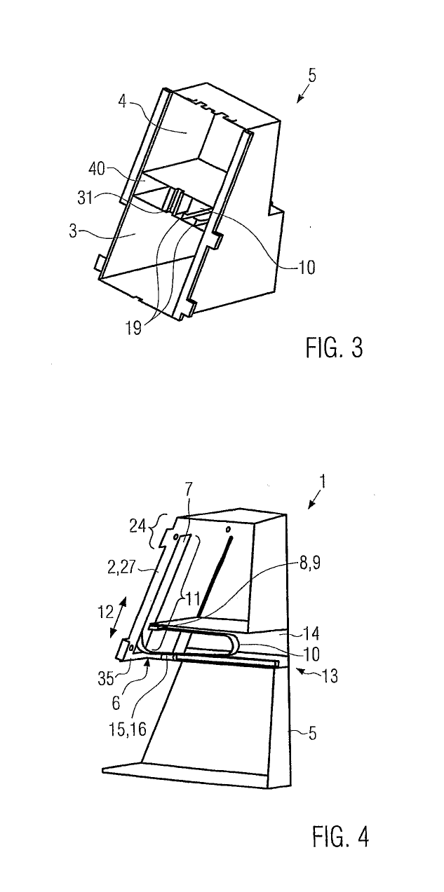

FIG. 3 illustrates the base body 5 without the aperture frame and without the cover panel illustrated in FIGS. 1 and 2. The top stowage compartment 4 and the bottom stowage compartment 3 in the form of essentially horizontally oriented stowage compartment spaces may be seen, between which a retraction and extraction compartment 10 and a guide groove 31 are disposed. A retractable and extractable flat cable 6 is disposed in the retraction and extraction compartment 10, also illustrated in FIG. 4, the purpose of which is to provide an electric supply to one or more electrical devices disposed in or mounted to the cover panel 2. The electrical devices may include display units, keys, switches or similar. The flat cable 6 may also exchange data between one or more electrical devices and/or a central data processing system in the vehicle.

As may also be seen from FIG. 3, another compartment 40 may be provided at the side, adjacent to the retraction and extraction compartment 10, which may be used as an alternative to or in addition to the compartment 10.

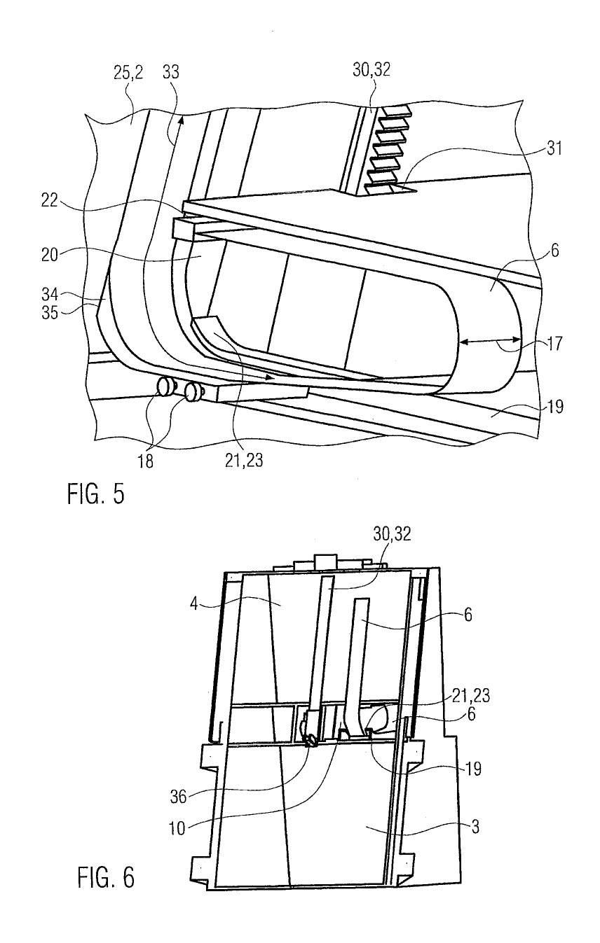

FIG. 4 illustrates a section along the plane IV-IV more or less at the center of the center console 1 illustrated in FIG. 1. The co-operating cover panel 2 is in its top end position 27 and is mounted in the co-operating aperture frame 29, also illustrated in FIG. 1 or 2, so as to be displaceable in the displacement direction 12. The flat cable 6 is disposed in the retraction and extraction compartment 10, with its first end 7 secured to an internal face 25, as also shown in FIG. 5 illustrating the cover panel 2, and its second end 8 is secured to a connection point 9 inside the retraction and extraction compartment 10. In this connection, the flat cable 6 is run through a top cover panel end portion 24 of the cover panel 2, where it is electrically connected to the co-operating electrical devices on the external face 26 of the cover panel 2.

Disposed on the internal face 25 of the cover panel 2, also illustrated in FIG. 5, is an elongate recess 35 extending along the displacement direction 12, in which the flat cable 6 is at least largely accommodated. At the bottom end of the cover panel 2, the flat cable 6 is then bent round in the direction of the retraction and extraction compartment 10 or towards the co-operating terminal opening 14 at the end 13 of this compartment and extends along the retraction and extraction compartment 10. In the region of the terminal opening 14 of the compartment 10, it is bent round again in the direction of the connection point 9, to which its second end 8 is affixed. As a rule, the connection point 9 is normally provided in the form of a plug connector 22, as also illustrated in FIG. 5, in which case it is in particular a plug connector of the ZIF (Zero Insertion Force) plug connector type.

As illustrated in FIGS. 4 and 5, a carriage 15 in the form of a guide part 16 is also disposed on a bottom face of the flat cable 6 directed towards a side wall of the retraction and extraction compartment 10. This guide part 16 is guided in an appropriate groove 19, illustrated in FIG. 5, along the retraction and extraction compartment 10. This guide part 16 prevents the flat cable 6 from assuming a multiple waved pattern or even moving out of line inside the retraction and extraction compartment.

As may be seen from FIG. 4, the cover panel 2 respectively covers the respective front opening 20 of the retraction and extraction compartment 10 in both its top and bottom end positions 27, 28, so that the flat cable 6 is 30 reliably covered in each of these and in any intermediate positions.

FIG. 5 illustrates the flat cable 6 shown in FIG. 4 but on an enlarged scale with additional details.

As may be seen in particular from this drawing, the carriage-type guide part 16 has guide projections 18 on each side projecting laterally in the transverse direction 17 beyond the flat cable 6, which are mounted so as to be displaceable in appropriately disposed guides 19 inside the retraction and extraction compartment 10. Across a length 33 essentially extending from the guide part 16 as far as its first end 7, illustrated in FIG. 4, the flat cable 6 is also disposed on a flexible strip 34. Its purpose is to secure the guide part 16 on the one hand and to guide the flat cable 6 in a portion 11 inside the recess 35, for example, on the internal face 25 of the cover panel 2, on the other hand.

The position of the cover panel 2 corresponds to the top end position 27 illustrated in FIG. 4. Disposed on the internal face 25 of the cover panel 2, laterally offset from the recess 35, is a guide projection 30 in the form of a toothed strip 32, which locates in the matching guide groove 31, also illustrated in FIG. 3, where it meshes with a rotatably mounted gear or similar, for example. The locating action of the toothed strip 32 and gear (not illustrated) is used on the one hand to guide the cover panel along the displacement direction 12 and on the other hand as a means of providing a resistance to movement, which in particular retains the cover panel 2 in its top respectively bottom end position 27, 28. This may also apply to all intermediate positions of the cover panel 2. Other systems for retaining the cover panel 2, at least in its end positions 27, 28, may also be used.

In the region of the front opening 20 of the retraction and extraction compartment 10, at least a part of its edge or an end 23 of the guide 19 is provided with an upwardly bent edge portion 21 as illustrated in FIG. 5. Its purpose is to bend the flat cable in the direction of the recess 35 on the one hand and to guide the flat cable into the retraction and extraction compartment 10 as the cover panel 2 moves into the bottom end position 28, illustrated in FIG. 2 on the other hand.

The co-operating plug connector 22 illustrated in FIG. 5 can be connected to another flat cable, not illustrated in detail, thereby enabling the flat cable 6 to be connected to the vehicle's on-board power and data supply.

FIG. 6 shows a diagram similar to that of FIG. 3, with a guide projection 30 in the form of a toothed strip 32 and the flat cable 6. The cover panel 2 can be secured to a fixing unit 36 on the guide projection 30 by its internal face 25. As may also be seen from FIG. 6, the end 23 of the guide 19 has upwardly bent edge portions 21 on both sides for deflecting the flat cable 6. The disposition of the guide projection 30 and flat cable 6 thus correspond to the stowage compartment 3 in its top end position 27.

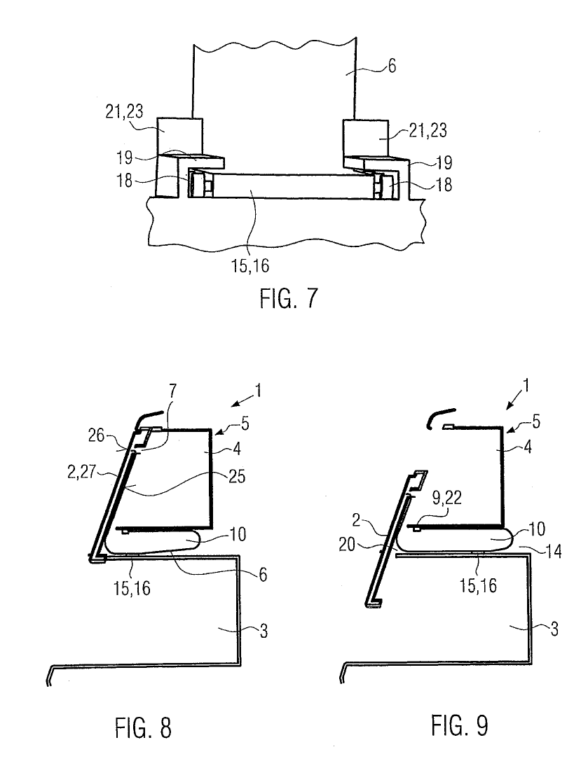

FIG. 7 illustrates the guide part 16 in the form of a carriage 15 on an enlarged scale. The various laterally projecting guide projections 18 are provided as a means of guiding the guide part 16 in the guides 19 extending in the longitudinal direction of the retraction and extraction compartment 10. The guides 19 are essentially provided in the form of upside-down L-shaped sections with the co-operating L-legs facing one another and extending above the guide projections 18.

Like the section illustrated in FIG. 4, FIGS. 8 to 10 illustrate the different positions of the cover panel 2 and the displacements of the flat cable 6 produced as a result.

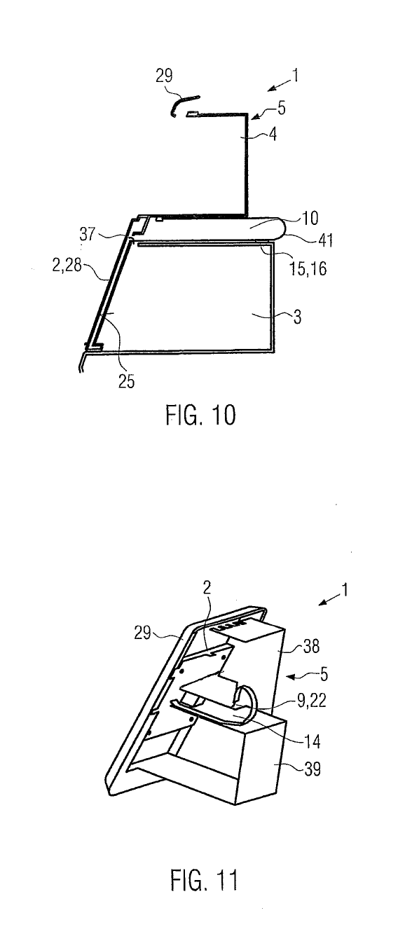

In FIG. 8, the cover panel 2 is disposed in its top end position 27 and the flat cable 6 is extracted from the retraction and extraction compartment 10 to the maximum. It essentially extends along the entire length of the internal face 25 in the displacement direction 12, where it is disposed with portion 11 in the co-operating recess 35, also illustrated in FIG. 5. As is best shown in FIG. 10, the flat cable 6 may be run into the cover panel 2 at an orifice 37 at its first end 7. The co-operating carriage 16 constituting a guide part 16 is disposed close to the front opening 20 of the retraction and extraction compartment 10.

It should also be pointed out that the same reference numbers are used to denote the same parts in all the drawings and only some of them are mentioned in connection with any one drawing.

In FIG. 9, the cover panel 2 is disposed in a middle position, in which both approximately half of the stowage compartment 3 and also of the stowage compartment 4 is exposed. The flat cable 6 now lies only above approximately half of the length of the cover panel 2 and does so along its internal face 25 on or in the recess 35. The carriage 15 serving as guide part 16 is pushed along the co-operating guide 19 in the direction towards the terminal opening 14 inside the retraction and extraction compartment 10.

In FIG. 10, the cover panel 2 is illustrated in its bottom end position 28, in which it totally covers the bottom stowage compartment 3 and the top stowage compartment 4 is totally exposed. As may also be seen, the cover panel 2 is bent inwards at its top and bottom ends so that it lies against a bottom, inwardly bent wall of the aperture frame 29 in its bottom end position 28 on the one hand and at its top end points essentially in the direction of a bottom wall of the top stowage compartment 4. When the cover panel 2 is in this position, the flat cable 6 is retracted into the retraction and extraction compartment 10 to its maximum, in which case the co-operating guide part 16 is pushed as far as the terminal opening 14 of the retraction and extraction compartment 10.

The dimensions of the retraction and extraction compartment 10 in the displacement direction 12 are selected precisely in this connection so that the end bend 41 of the flat cable 6 has a radius which is big enough to prevent too pronounced bending or misalignment of the flat cable in this region.

FIG. 11 illustrates an example of another embodiment of the center console 1 proposed by the invention. It essentially differs from the embodiment described as an example so far only in respect of the disposition of the connection point 9 and co-operating plug connector 22. Whereas the latter is disposed close to the front opening 20 of the retraction and extraction compartment 10 in the first embodiment described as an example, it is disposed in the region of the terminal opening 14 in the embodiment illustrated as an example in FIG. 11.

In addition, the flat cable 6 can also be connected to the cover panel 2 by its first end 7, as illustrated in FIGS. 8 and 11 for example, and run into the cover panel essentially in the middle rather than at a top cover panel end portion 24. This being the case, the flat cable 6 is respectively pulled out of the retraction and extraction compartment 10 into the top or bottom end position 27, 28 as the cover panel 2 is moved accordingly, as illustrated in FIG. 11, and is pushed to the maximum into this compartment when the cover panel 2 is in the middle position illustrated in FIG. 11, in which case it may lie against rear faces 38, 39 of the stowage compartments 3, 4.

However, it is also possible for the flat cable 6 to be connected to the cover panel 2 in the case of the embodiment illustrated as an example in FIG. 11 in the same way as with the first embodiment illustrated as an example in FIGS. 1 to 10.

The co-operating base body 5 illustrated in FIG. 3 in particular is advantageously manufactured as a single piece incorporating the individual parts illustrated and may be made from an appropriate plastic material, for example. As a rule, the base body 5 is firstly inserted in an appropriate orifice in the vehicle interior and then fitted with the aperture frame provided with the displaceably mounted cover panel. It should also be pointed out that the co-operating stowage compartments can not only be used as stowage compartments but may also be used to mount additional electronic units in one or both stowage compartments. These will then be rendered accessible or covered depending on the displacement of the cover panel.

What is claimed:

1. A center console for a vehicle, comprising:
a base body incorporating first and second stowage compartments and a retraction and extraction compartment;
a cover panel for selectively covering at least one of the first and second stowage compartments, the cover panel being slidingly mounted to the base body;
a flexible flat cable connected at a first end to the cover panel and at a second end to the base body at a connection point;
wherein the retraction and extraction compartment is open at least towards the cover panel and wherein at least a portion of the flat cable is mounted in the retraction and extraction compartment such that the flat cable can be retracted and extracted when the cover panel is displaced in a displacement direction.

2. The center console of claim 1 wherein the retraction and extraction compartment is disposed between the first and second stowage compartments.

3. The center console of claim 1 wherein the retraction and extraction compartment extends essentially perpendicular to the displacement direction of the cover panel.

4. The center console of claim 3 wherein the retraction and extraction compartment has a terminal opening at an end disposed opposite the cover panel for running the flat cable in the direction of the connection point.

5. The center console of claim 4 wherein the connection point essentially co-operates with the terminal opening of the retraction and extraction compartment.

6. The center console of claim 1 wherein the flat cable is guided as it moves inside the retraction and extraction compartment.

7. The center console of claim 1 further comprising an essentially carriage-type guide part moveably disposed in the retraction and extraction compartment, wherein the flat cable is secured to the guide part.

8. The center console of claim 7 wherein the guide part has guide projections on both sides projecting in a transverse direction of the flat cable and beyond the flat cable, wherein the guide projections are received by guides disposed inside the retraction and extraction compartment.

9. The center console of claim 1 wherein the connection point is disposed inside the retraction and extraction compartment.

10. The center console of claim 1 wherein the retraction and extraction compartment further comprises a guide having an outwardly bent edge portion at an end directed towards the cover panel.

11. The center console of claim 1 wherein the flat cable is connected to a cover panel end portion on an internal face that faces toward the first and second stowage compartments.

12. The center console of claim 11 wherein the cover panel has a recess disposed on an internal face for accommodating the flat cable.

13. The center console of claim 11 wherein the cover panel has a guide projection generally disposed at a center of the internal face, wherein the guide projection is guided in a guide groove of the base body.

14. The center console of claim 13 wherein the guide projection is provided in the form of a toothed strip.

15. The center console of claim 1 wherein the cover panel includes an external face and at least one of a key, button, and a display unit disposed proximate the external face and electrically connected to the flat cable.

16. The center console of claim 1 wherein the cover panel is disposed so that it overlaps the retraction and extraction compartment in its respective end positions in the displacement direction.

17. The center console of claim 1 wherein the flat cable runs directly at a side inside the retraction and extraction compartment.

18. The center console of claim 1 further comprising an aperture frame in which the cover panel is displaceably mounted, wherein the aperture frame is releasably fitted on the base body.

19. The center console of claim 1 wherein the flat cable is mounted on a flexible strip at least along a part of its length.
